(19) United States
(12) Patent Application Publication
(10) Pub. No.: US 2009/0211777 A1
(43) Pub. Date: Aug. 27, 2009

(54) PLUG IN DEVICE DIMENSIONING SYSTEM AND METHOD

(76) Inventors: Jeffrey Bankers, Phoenix, AZ (US); Sanam Nassirpour, Phoenix, AZ (US)

Correspondence Address: SNELL & WILMER, LLP (Dial Corp), ONE ARIZONA CENTER, 400 E. VAN BUREN, PHOENIZ, AZ, 85004-2202, US

(21) Appl. No.: 12/036,814

(22) Filed: Feb. 25, 2008

(51) Int. Cl. H02G 3/14

(52) U.S. Cl. 174/66

(57) ABSTRACT

In general, the present disclosure provides a method of designing, and system for implementing, a plug-in-type device capable of coupling to a first plug of an outlet receptacle, and configured to allow utilization of a second plug, or inhibit the use of the second plug of the receptacle. For example, a device in accordance with an exemplary embodiment of the present invention comprises a plug portion capable of electrically coupling to one of at least two receptacles of a power outlet, a body portion comprising a vertical and a horizontal dimension, capable of coupling to the plug portion, and having the body portion dimensioned to allow or disallow utilization of a second of the at least two receptacles.

### FIELD

The present invention generally relates to electrical connectors and, more particularly, to systems and methods for configuring plug-in devices.

### BACKGROUND

Certain types of compact electrical devices are designed to plug directly into one electrical outlet of a dual outlet receptacle. A user may want to utilize the remaining outlet for other purposes. In such cases, it may be desirable to dimension the device to allow the remaining outlet to remain uncovered, thereby maintaining the functionality of the outlet, and maintaining safe use of the remaining outlet.

Wall outlet mounted electric air freshener devices are increasing in size due, at least in part, to a number of innovations in the devices, which may include added functionality and new methods of fragrance dispersal. With the increase in size, devices have begun to encroach the area of the second outlet in the typical horizontal and vertical outlet placement orientations. As these devices increase in size, it is desirable for the consumer to maintain functional use of their second outlet plug.

Some plug-in devices partially cover the remaining outlet of a duplex receptacle. This may cause the user to alter another electrical device to allow it to plug into the remaining, partially covered plug. It is an objective of this invention to provide embodiments and methods of designing a plug-in device that will use the occupied outlet while either allowing use of the remaining outlet, or prohibit utility of the remaining plug for safety, among other considerations.

### SUMMARY

In general, the present disclosure provides a method of designing, and system for implementing, a plug-in-type device capable of coupling to a first plug of an outlet receptacle, and configured to allow utilization of a second plug, or inhibit the use of the second plug of the receptacle. For example, a device in accordance with an exemplary embodiment of the present invention comprises a plug portion capable of electrically coupling to one of at least two receptacles of a power outlet, a body portion comprising a vertical and a horizontal dimension, capable of coupling to the plug portion, and having the body portion dimensioned to allow or disallow utilization of a second of the at least two receptacles.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 is an elevational view of a plug-in type device, according to an embodiment of the present invention;

FIG. 2 is a plan view of a typical vertical electrical plug configuration, according to an embodiment of the present invention;

FIG. 3 is a plan view of a typical horizontal electrical plug configuration, according to an embodiment of the present invention;

FIG. 4 is a flow diagram of a method, according to an embodiment of the present invention; and

FIG. 5 is a diagram of a decision tree, according to an embodiment of the present invention.

### DETAILED DESCRIPTION

The following description is of exemplary embodiment of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the disclosure.

As noted above, in general, the present disclosure provides a method of designing, and system for implementing, a plug-in-type device capable of coupling to a first plug of an outlet receptacle, and configured to either allow utilization of a second plug or inhibit the use of the second plug of the receptacle. For example, a device in accordance with an exemplary embodiment of the present invention comprises a plug portion capable of electrically coupling to one of at least two receptacles of a power outlet, a body portion comprising a vertical and a horizontal dimension, capable of coupling to the plug portion, and having the body portion dimensioned to allow or disallow utilization of a second of the at least two receptacles. Additionally, briefly, though two outlet power outlets are commonly referred to herein, those skilled in the art will appreciate that power outlets having additional outlets (e.g., fourplex or more) may likewise fall within the context of the present invention.

More specifically, in accordance with various aspects of the present invention the plug-in device is configured such that it either completely covers the neighboring receptacle it is not plugged into or does not cover the neighboring receptacle at all.

In this regard, with reference to the accompanying Figures, a non-limiting embodiment of a device capable of plugging in to a receiver outlet in accordance with the present invention is illustrated. The device is configured such that when placed in one of the receptacles 202, 204, 302, 304, loci A is vertically and horizontally aligned with loci B. When placed in the other, loci A is vertically and horizontally aligned with loci C.

More specifically, device 100 includes a plug portion 102 and a body portion 104. In an exemplary embodiment, plug portion 102 is capable of plugging into a common power receptacle outlet. Furthermore, plug portion 102 is configured to be coupled to body portion 104. Body portion 104 may be dimensioned to either allow use of another plug in the outlet, or prohibit the use of the remaining plug in the outlet.

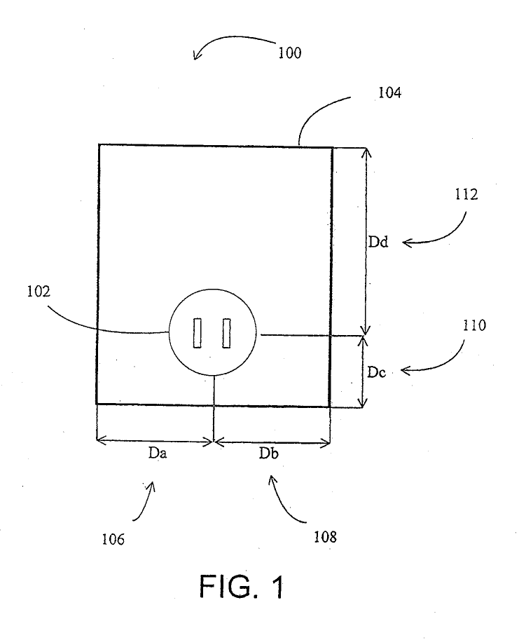

In accordance with an exemplary embodiment, body portion 104 has vertical and horizontal dimensions. Body portion 104 dimensions include Da 106, a horizontal dimension from the center of plug portion 102 to the edge of body portion 104. Furthermore, body portion 104 dimensions further include Db 108, a horizontal dimension from the center of plug portion 102 to the edge of body portion 104, as shown in FIG. 1. In an exemplary embodiment, body portion 104 is configured to be symmetric about a vertical axis of plug portion 102, and Da 106 equals Db 108. In another exemplary embodiment, other dimensions of body portion 104 include Dc 110, a vertical dimension from the center of plug portion 102 to the bottom of body portion 104, and Dd 112, a vertical dimension from the center of plug portion 102 to the top of body portion 104.

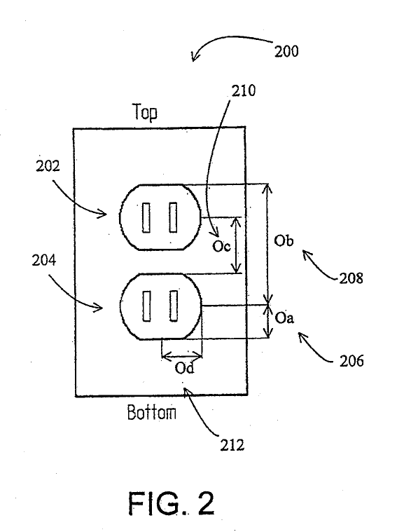

In accordance with an exemplary embodiment and with reference to FIG. 2, device 100 couples with a typical design of a vertical power outlet 200 comprising two vertical receptacles. Vertical power outlet 200 includes a top receptacle 202 and a bottom receptacle 204. In an exemplary embodiment, vertical power outlet 200 is, for example, a power outlet commonly found in residential and commercial buildings. Furthermore, vertical power outlet 200 can be any suitable vertical alignment of receptacles 202, 204, where a plug-in device may be used.

In an exemplary embodiment, vertical power outlet 200 includes various dimensions. Of particular note, vertical power outlet 200 includes Oa 206, a vertical dimension from the center of bottom receptacle 204 to the bottom edge of bottom receptacle 204. Furthermore, vertical power outlet 200 includes Ob 208, a vertical dimension from the center of bottom receptacle 204 to the top of top receptacle 202.

Additionally, vertical power outlet 200 includes Oc 210, a vertical dimension from the top of bottom receptacle 204 to the center of top receptacle 202. Vertical power outlet 200 also includes Od 212, a horizontal dimension from the center of bottom receptacle 204 to the edge of bottom receptacle 204.

In an exemplary embodiment of the present invention, the center to edge of the bottom receptacle vertical dimension Oa 206 is about 13 mm, the center of bottom receptacle to top of top receptacle vertical dimension Ob 208 is about 51 mm, the top of bottom receptacle to center of top receptacle vertical dimension Oc 210 is about 23 mm, and the center to edge of bottom receptacle horizontal dimension Od 212 is about 16 mm. It will be appreciated by those skilled in the art that other dimensions are possible, and the above dimensions are but one embodiment. As with the number of outlets, the scope of the present invention is not limited by the dimensions of the power outlet or the apparatus.

In one embodiment of device 100, body portion 104 may be rotated about plug portion 102. This embodiment allows body portion 104 to be substantially vertical when plug portion 102 is connected to a receptacle that is either vertically orientated or horizontally orientated. In another embodiment, body portion 104 is substantially horizontal when plug portion 102 is connected to a receptacle that is either vertically orientated or horizontally orientated. Furthermore, it will be appreciated by one skilled in the art that other orientations of body portion 104 are possible. The scope of the present invention is not limited by the orientation of body portion 104 to plug portion 102.

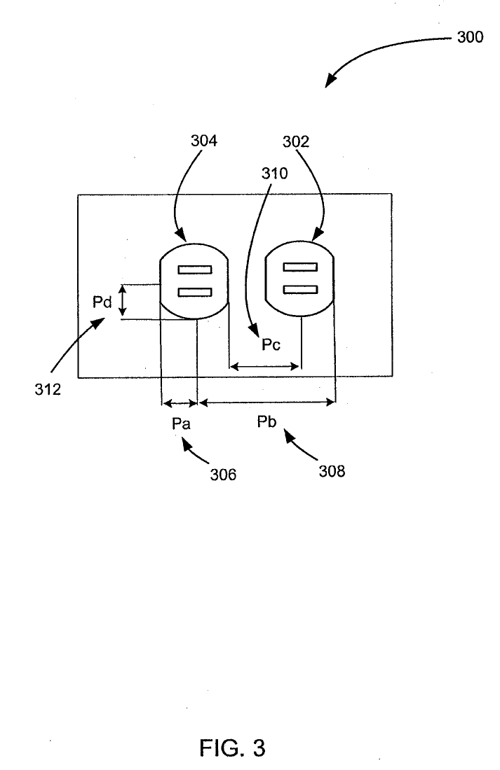

FIG. 3 shows a horizontal power outlet 300 in a horizontal orientation, with horizontal receptacle orientation. In an exemplary embodiment, horizontal power outlet 300 further comprises a right receptacle 302 and a left receptacle 304. In an exemplary embodiment and with reference to FIG. 3, horizontal power outlet 300 is further described by additional dimensions. For example, Pa 306 is the horizontal dimension from the outside edge of a receptacle to the center of the same receptacle. Pb 308 is the horizontal dimension from the center of a receptacle to the outside edge of another receptacle. Furthermore, Pc 310 is the horizontal dimension from the center of a receptacle to the inside edge of another receptacle. Pd 312 is the vertical dimension from the center of a receptacle to the bottom edge of the same receptacle.

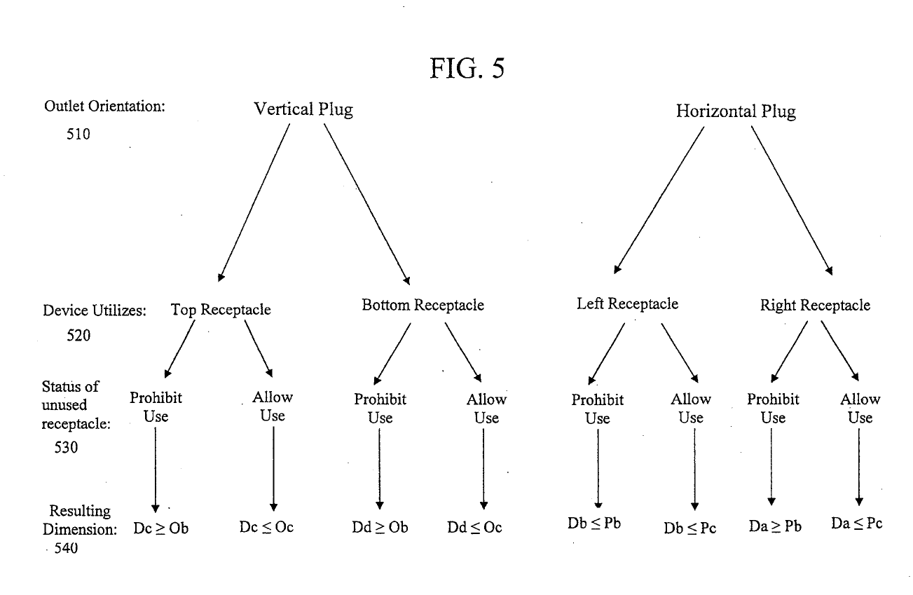

With reference to FIG. 5, an exemplary method of designing device 100 includes deciding upon a primary objective and arrangement of the device. The primary arrangement of the device includes selecting the outlet orientation 510 and the intended receptacle for device utilization 520. The primary objective comprises electing the status of the unused receptacle 530. For example, the primary objective and arrangement may be to prohibit use of a top receptacle when the device is utilizing a bottom receptacle of a vertical power outlet. Once the primary objective and arrangement are selected, the resulting dimension 540 is determined. Continuing the above example and referencing FIG. 5, to prohibit use of a top receptacle when the device is utilizing a bottom receptacle of a vertical power outlet results in the dimension Dd≧Ob.

In addition to selecting dimensions of the device to achieve the primary objective, in the exemplary method of design, the device also meets the dimension requirements of other potential arrangements. The method of selecting plug-in dimensions is such that the plug-in dimensions satisfy not only the primary objective and arrangement, but also additional arrangements which result in a satisfactory status of the unused receptacle. Continuing the above example, if the device is plugged into the top receptacle instead of the intended bottom receptacle, the device will either prohibit or allow utilization of the bottom receptacle. In another exemplary method, there are multiple arrangements included in the primary design objective.

In an exemplary embodiment, potential primary objectives and arrangements include, but are not limited to, combinations of a vertical plug or a horizontal plug, the device utilizing a top receptacle, bottom receptacle, left receptacle, or right receptacle, and either allowing or prohibiting use of additional unused receptacles. Exemplary embodiments of potential primary design objectives and the suitable device dimensions are listed hereinafter.

In an exemplary embodiment, device 100 is configured to fully cover bottom receptacle 204, such that no other device and/or object may be inserted into bottom receptacle 204. In an exemplary embodiment, bottom receptacle 204 is appropriately utilized when device 100 is plugged into bottom receptacle 204. Appropriate utilization occurs when Dc is greater than or equal to Oa 206. In another exemplary embodiment, bottom receptacle 204 is properly utilized when device 100 is plugged into bottom receptacle 204, occurring when Dd 112 is greater than or equal to Oa 206.

In an exemplary embodiment, device 100 is plugged into bottom receptacle 204 of vertical power outlet 200, and device 100 is designed to prevent the use of top receptacle 202 of vertical power outlet 200, by not allowing another device and/or object to be inserted into top receptacle 202. Prevention occurs when Dd 112 is greater than or equal to Ob 208.

In another exemplary embodiment, device 100 is plugged into bottom receptacle 204 of vertical power outlet 200, and device 100 is configured to allow use of top receptacle 202. Top receptacle can be used when Dd 112 is less than or equal to Oc 210.

In another exemplary embodiment, device 100 is designed to allow utilization of bottom receptacle 204 when device 100 is plugged into top receptacle 202 of vertical power outlet 200. Utilization occurs when Dc 110 is less than or equal to Oc 210. This configuration allows another device to utilize bottom receptacle 204 of vertical power outlet 200 concurrently with device 100 utilizing top receptacle 202.

In an exemplary embodiment, device 100 is designed to prevent utilization of bottom receptacle 204 when device 100 is plugged into top receptacle 202 of vertical power outlet 200. Prevention occurs when Dc 110 is greater than or equal to Ob 208. This configuration of device 100 is such that no other device and/or object may be inserted into bottom receptacle 204

In an exemplary embodiment, device 100 is placed in either top receptacle 202 or bottom receptacle 204 of vertical power outlet 200, and device 100 is configured to prevent another device and/or object from being inserted into the utilized receptacle. This prevention configuration is where both Da 106 and Db 108 are greater than or equal to Od 212.

Furthermore, it will be appreciated by those skilled in the art that rotating the vertical power outlet and receptacles will result in the same or similar dimensions and dimensioning considerations.

In an exemplary embodiment of the present invention, device 100 and body portion 104 have a vertical symmetry axis through plug portion 102. With reference to a horizontal power outlet 300, plug portion 102 can be plugged into either right receptacle 302 or left receptacle 304. In an exemplary embodiment, Da and Db are equal dimensions. Furthermore, in an exemplary embodiment, device 100 is utilizing a receptacle and is configured to prevent the use of another receptacle in a horizontal power outlet. For example, preventing another receptacle's use occurs when Pb is less than or equal to Da. This configuration insures that no other device and/or object may be inserted into either of the receptacles 302 and 304.

In accordance with an exemplary embodiment of the present invention, device 100 is plugged into right receptacle 302 of horizontal power outlet 300 and left receptacle can still be utilized. Utilizing both receptacles of horizontal power outlet 300 occurs when device 100 is configured so that Da is less than or equal to Pc. This design allows device 100 to use a receptacle while simultaneously providing access to another receptacle.

In another exemplary embodiment, device 100 lacks symmetry around plug portion 102 and device 100 is placed in right receptacle 302. In an exemplary embodiment, device 100 is configured to allow full use of left receptacle 304 while protecting right receptacle 302. For example, Da is less than or equal to Pc to allow access to left receptacle 304, and Db is greater than or equal to Pa to protect right receptacle 302 from insertion of another device and/or object. In another exemplary embodiment, device 100 is plugged into left receptacle 302 and the same or similar dimension configurations can be implemented to allow access to right receptacle 302 while protecting left receptacle 304.

In an exemplary embodiment, device 100 is plugged into either right receptacle 302 or left receptacle 304 and Dc 110 and Dd 112 are greater than Pd 312.

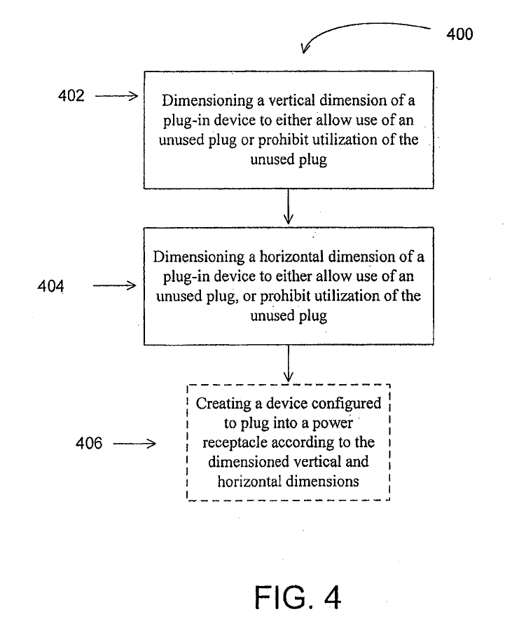

In an exemplary embodiment and with reference to FIG. 4, a method 400 of designing a device with dimensions capable of being plugged into a power outlet receptacle comprises dimensioning a vertical dimension at 402, dimensioning a horizontal dimension at 404 and creating the device according to the dimensioned vertical and horizontal dimensions optionally at 406. Dimensioning a vertical dimension 402 of a plug in device, to either allow use of the remaining receptacle or prohibiting the utilization of the remaining receptacle may be accomplished at 402. According to the description above, the device may be vertically dimensioned to allow usage of the remaining receptacle not utilized or may be vertically dimensioned to completely cover the receptacle not utilized for safety considerations, among others.

Furthermore, in an exemplary embodiment, horizontal dimension 404 of a plug in device is designed to accomplish utility and dimension objectives. For example, the horizontal dimensions of the device capable of plugging into a power outlet may be designed to either allow utilization of a receptacle not utilized, or completely cover the receptacle not utilized for safety considerations, among others.

Once the vertical dimension 402 and horizontal dimension 404 are determined, a device may be created according to those dimensions at 406.

In accordance with an exemplary embodiment, the dimensions of a plug-in device are not dependant on the orientation of a power outlet in order to allow or disallow utilization of a second receptacle. In an exemplary embodiment, the plug-in device is configured to disallow secondary utilization of a used plug-in. For example, the plug-in device disallows secondary utilization of a used plug-in when the body portion dimension from the center of the used plug-in to the edge of the body portion opposite the used plug-in is greater than or equal to the dimension from the center of the used plug-in to the edge of the used plug-in.

In an exemplary embodiment, the plug-in device is configured to disallow utilization of an unused plug-in. For example, an unused plug-in cannot be used when the plug-in device dimension from the center of the plug portion to the edge of the body portion closest to the unused plug-in is greater than or equal to the dimension from the center of the used plug-in to the edge of the unused plug-in which is farthest from the used plug-in.

In an exemplary embodiment, a plug-in device is configured to allow utilization of an unused plug-in. For example, an unused plug-in is available when the plug-in device dimension from the center of the plug portion to the edge of the body portion closest to the unused plug-in is less than or equal to the dimension from the center of the used plug-in to the edge of the unused plug-in which is nearest the used plug-in.

Other advantages and structural details of the invention will be apparent from the attached figures, which will be well understood by those skilled in the art. The present invention has been described above with to a particular exemplary embodiment. However, many changes, combinations and modifications may be made to the exemplary embodiments without departing from the scope of the present invention.

1. An apparatus designed to plug into a power outlet, comprising:
a plug portion capable of electrically coupling to one of at least two receptacles of the power outlet; and
a body portion comprising a vertical dimension and a horizontal dimension, capable of coupling to said plug portion, wherein said body portion is dimensioned to allow or disallow utilization of a second of the at least two receptacles.

2. An apparatus designed to disallow utilization of an unused plug-in and disallow utilization of a used plug-in, the apparatus comprising:
a plug portion capable of electrically coupling to a power outlet, the power outlet comprising a first receptacle and a second receptacle;
a body portion comprising a first dimension and a second dimension, the body portion capable of coupling to the plug portion;
wherein the apparatus is electrically coupled to the first receptacle;
wherein the first dimension from the center of the plug portion to the edge of the body portion closest to the second receptacle is greater than or equal to the dimension from the center of the first receptacle to the edge of the second receptacle farthest from the first receptacle; and
wherein the second dimension from the center of the plug portion to the edge of the body portion opposite the second receptacle is greater than or equal to the dimension from the center of the first receptacle to the edge of the first receptacle.

3. An apparatus designed to allow utilization of an unused plug-in and disallow utilization of a used plug-in, the apparatus comprising:
a plug portion capable of electrically coupling to a power outlet, the power outlet comprising a first receptacle and a second receptacle;
a body portion comprising a first dimension and a second dimension, the body portion capable of coupling to the plug portion;
wherein the apparatus is electrically coupled to the first receptacle;
wherein the dimension from the center of the plug portion to the edge of the body portion closest to the second receptacle is less than or equal to the dimension from the center of the first receptacle to the edge of the second receptacle nearest the first receptacle; and
wherein the second dimension from the center of the plug portion to the edge of the body portion opposite the second receptacle is greater than or equal to the dimension from the center of the first receptacle to the edge of the first receptacle.

4. A method of designing a plug-in device configuration, the method comprising the steps of:
selecting a first dimension of a body portion of the plug-in device;
selecting a second dimension of the body portion of the plug-in device; and
designing the plug-in device based at least in part upon the first dimension and the second dimension,
wherein the plug-in device is configured to couple to a first receptacle of a power outlet, and wherein the body portion is configured to allow or disallow utilization of a second receptacle of the power outlet.

5. A method of designing a plug-in device that is configured to plug into a power outlet, wherein the power outlet has a first receptacle and a second receptacle, the method comprising the steps of:
determining that the plug-in device will electrically couple with the first receptacle;
allowing utilization of the second receptacle by dimensioning the center of the plug-in device to the edge of the plug-in device nearest the second receptacle to be less than or equal to the center of first receptacle to the near edge of the second receptacle;
disallowing utilization of the first receptacle by dimensioning the center of the plug-in device to the edge of the plug-in device opposite the second receptacle to be greater than or equal to the center of the first receptacle to the edge of the first receptacle; and
designing the plug-in device to conform with the first dimension and the second dimension.

6. A method of designing a plug-in device that is configured to plug into a power outlet, wherein the power outlet has a first receptacle and a second receptacle, the method comprising the steps of:
determining that the plug-in device will electrically couple with the first receptacle;
disallowing utilization of the second receptacle by dimensioning the center of the plug-in device to the edge of the plug-in device nearest the second receptacle to be greater than or equal to the center of first receptacle to the edge of the second receptacle farthest from the first receptacle;
disallowing utilization of the first receptacle by dimensioning the center of the plug-in device to the edge of the plug-in device opposite the second receptacle to be greater than or equal to the center of the first receptacle to the edge of the first receptacle; and
designing the plug-in device to conform with the first dimension and the second dimension.
